(19) United States
(12) Patent Application Publication
(10) Pub. No.: US 2025/0221590 A1
(43) Pub. Date: Jul. 10, 2025

(54) VACUUM CLEANER

(71) Applicant: SAMSUNG ELECTRONICS CO., LTD., Suwon-si (KR)

(72) Inventors: Incheol LEE, Suwon-si (KR); Nokhaeng LEE, Suwon-si (KR); Jeonghoon KANG, Suwon-si (KR); Jeawon LEE, Suwon-si (KR)

(73) Assignee: SAMSUNG ELECTRONICS CO., LTD., Suwon-si (KR)

(21) Appl. No.: 19/094,304

(22) Filed: Mar. 28, 2025

(30) Foreign Application Priority Data
Oct. 20, 2022 (KR) 10-2022-0136031

(51) Int. Cl. A47L 9/00; G10K 11/16

(52) U.S. Cl. CPC A47L 9/0081; G10K 11/161; G10K 2210/105

(57) ABSTRACT

A vacuum cleaner comprises a suction motor, a suction fan which is to be driven by the suction motor to generate airflow, and a main body housing which accommodates the suction motor and the suction fan. The vacuum cleaner comprises a silencer having one end coupled to the main body housing to reduce noise inside the main body housing during an operation of the intake motor. The silencer includes a contact surface disposed in the one end of the silencer to face the suction fan so as to contact the airflow, and includes a silencer chamber partitioned from the interior of the main body housing by means of the contact surface. The silencer includes a plurality of through-holes arranged in the contact surface to have the noise chamber to be in communication with an inside of the main body housing through the plurality of through holes.

### CROSS REFERENCE TO THE RELATED APPLICATION

This application is a continuation application, filed under 35 U.S.C. § 111 (a), of International Application PCT/KR2023/015356 filed Oct. 5, 2023, and is based on and claims priority under 35 U.S.C. § 119 to Korean Patent Applications No. 10-2022-0136031, filed on Oct. 20, 2022, in the Korean Intellectual Property Office, the disclosures of which are incorporated by reference herein in their entireties.

### TECHNICAL FIELD

The disclosure relates to a vacuum cleaner, and more particularly to a vacuum cleaner including a silencer for reducing operational noise.

### BACKGROUND ART

A vacuum cleaner is a device that removes rubbish from an indoor space to make it clean, and vacuum cleaners are commonly used in homes.

There are two types of vacuum cleaner: canister type and upright type, and more recently robotic vacuum cleaners have become popular as they drive themselves around an area to be cleaned without any user intervention, drawing in rubbish, such as dust, from a surface to be cleaned.

Vacuum cleaners use high-performance motors to increase intake power. This causes loud noise from the motor and the fan attached to the motor.

To reduce such noise, attempts have consistently been made to reduce noise by applying additional structures around the motor, but recently, due to the miniaturization of vacuum cleaners, the space for installing additional structures around the motor has become limited.

In addition, noise reduction technologies considered in the past have used muffler-type or porous structures to reduce the velocity of the flow discharged from the motor, which often results in a decrease in the performance of the vacuum cleaner due to the reduction in flow velocity.

### DISCLOSURE

### Technical Problem

An embodiment of the present disclosure provides a vacuum cleaner capable of minimizing the increase in volume of a main body.

An embodiment of the present disclosure provides a vacuum cleaner capable of reducing noise without applying additional structures around a motor.

An embodiment of the present disclosure provides a vacuum cleaner capable of only reducing noise that causes discomfort.

An embodiment of the present disclosure provides a vacuum cleaner capable of removing only certain bands of noise frequencies.

An embodiment of the present disclosure provides a vacuum cleaner capable of selecting noise frequencies to be removed.

An embodiment of the present disclosure provides a vacuum cleaner capable of maintaining the performance of the vacuum cleaner.

An embodiment of the present disclosure provides a vacuum cleaner that does not reduce the velocity of the flow.

An embodiment of the present disclosure provides a vacuum cleaner with an attached silencer that does not allow flow to pass through.

### Technical Solution

An embodiment of the present disclosure provides a vacuum cleaner includes an intake motor, an intake fan to be driven by the intake motor to generate an airflow, a main body housing configured to accommodate the intake motor and the intake fan. The vacuum cleaner includes a silencer having one end coupled to the main body housing and configured to reduce noise inside the main body housing during an operation of the intake motor. The silencer includes a contact surface disposed in the one end of the silence to face the intake fan so as to be in contact with the airflow. The silencer includes a noise chamber partitioned from an inside of the main body housing by the contact surface. The silencer includes a plurality of through holes arranged in the contact surface to have the noise chamber to be in communication with an inside of the main body housing through the plurality of through holes.

The main body housing may include an opening on one side. The one end of the silencer may be inserted into the opening and detachably mounted on the main body housing.

The main body housing may further include an exhaust hole through which air is discharged to an outside of the main body housing. The plurality of through holes may be positioned on a downstream side of the exhaust hole in a direction of the airflow inside the main body housing.

The plurality of through holes may be micropores. The plurality of through holes may be uniformly arranged on the contact surface.

The silencer may further include a chamber inner wall that partitions the noise chamber into a plurality of chambers.

The silencer may further include a mesh cover configured to cover the micropores.

The silencer may further include a chamber inner wall that partitions the noise chamber into a plurality of chambers. Each of the plurality of through holes may be arranged to correspond to each of the plurality of chambers and to be in communication with each of the plurality of chambers, respectively.

The silencer may further include a mesh cover configured to cover the plurality of through holes.

The silencer may further include a through hole guard arranged to be spaced apart from the contact surface to cover the plurality of through holes.

The plurality of through holes may include first through holes having a first diameter. The plurality of through holes may include second through holes having a second diameter different from the first diameter. The silencer may further include a chamber inner wall partitioning the noise chamber into a plurality of chambers. The plurality of through holes may be arranged to correspond to each of the plurality of chambers to be in communication with each of the plurality of chambers, respectively.

The first through holes and the second through holes may be arranged alternately along a circumferential direction of the contact surface. The silencer may further include a slit cover configured to cover the plurality of through holes, and rotatable to selectively open or close the first through holes and the second through holes.

The vacuum cleaner may further include a cylindrical piston housing including a circular coupler. An other end of the silencer may be inserted into the coupler so as to be in communication with the piston housing. The silencer may be movable within the piston housing so as to change the volume of the noise chamber.

An embodiment of the present disclosure provides a vacuum cleaner includes an intake head configured to draw in foreign matter from a surface to be cleaned, and a foreign matter filtering device configured to filter out foreign matter from the air drawn in from the intake head. The vacuum cleaner includes a main body housing arranged on an upper portion of the foreign mater fileting device, accommodating an intake motor and an intake fan driven by the intake motor to generate an airflow, and including an opening on one side. The vacuum cleaner includes a silencer coupled to the main body housing and configured to reduce noise inside the main body housing. The silencer includes a contact surface arranged to face the intake fan so as to be in contact with the airflow. The silencer includes a noise chamber partitioned from an inside of the main body housing by the contact surface. The silencer includes a plurality of through holes arranged in the contact surface to communicate the inside of the main body housing with the noise chamber. The silencer may be inserted into the opening and detachably mounted on the main body housing.

The plurality of through holes may be provided as micropores. The plurality of through holes may be uniformly arranged on the contact surface. The silencer may further include a chamber inner wall that partitions the noise chamber into a plurality of chambers.

The silencer may further include a chamber inner wall that partitions the noise chamber into a plurality of chambers. The plurality of through holes may be arranged to correspond to the plurality of chambers, respectively, to communicate with the respective plurality of chambers.

The silencer may further include a through hole guard arranged to be spaced apart from the contact surface to cover the plurality of through holes.

The plurality of through holes may include a first through hole having a first diameter. The plurality of through holes may include a second through hole having a second diameter different from the first diameter. The silencer may further include a chamber inner wall partitioning the noise chamber into a plurality of chambers. The plurality of through holes may be arranged to correspond to each of the plurality of chambers to communicate with each chamber.

The first through hole and the second through hole may be arranged alternately along a circumferential direction of the contact surface. The silencer may be configured to cover the plurality of through holes. The silencer may further include a slit cover rotatable to open or close the first through hole and the second through hole.

The silencer may further include a mesh cover configured to cover the plurality of through holes.

The vacuum cleaner may further include a cylindrical piston housing including a circular coupler. The silencer may be inserted into the coupler so as to be in communication with the piston housing. The silencer may be movable within the piston housing so as to change the volume of the noise chamber.

### Advantageous Effects

According to various embodiments of the present disclosure, the silencer that is separately mounted to the main body housing may be provided to minimize the increase in volume of the main body of the vacuum cleaner itself.

According to various embodiments of the present disclosure, the silencer may be operated during use of the vacuum cleaner, thereby selecting noise frequencies in a target band to be removed.

According to various embodiments of the present disclosure, the velocity of the flow may not be reduced because the flow does not pass through the plurality of through holes, thereby preventing the performance of the vacuum cleaner from deteriorating.

### DESCRIPTION OF DRAWINGS

FIG. 1 is a perspective view illustrating a vacuum cleaner including a silencer, according to an embodiment.

FIG. 2 is a perspective view of a main body of FIG. 1.

FIG. 3 is a cross-sectional view of the vacuum cleaner of FIG. 2 cut along A-A′.

FIG. 4 is a partially exploded view of the vacuum cleaner including the silencer, according to an embodiment.

FIG. 5 is a view of FIG. 4 from a different angle.

FIG. 6 is a perspective view illustrating a silencer according to an embodiment.

FIG. 7 is a perspective view of the silencer of FIG. 6 cut along B-B′.

FIG. 8 is a perspective view of a chamber inner wall of the silencer according to an embodiment.

FIG. 9 is a perspective view illustrating a silencer according to an embodiment.

FIG. 10 is a perspective view illustrating a silencer according to an embodiment.

FIG. 11 is a perspective view of the silencer of FIG. 10 cut along C-C′.

FIG. 12 is a perspective view illustrating a silencer according to an embodiment.

FIG. 13 is a perspective view illustrating a silencer according to an embodiment.

FIG. 14 is a side view of FIG. 13.

FIG. 15 is a perspective view illustrating a silencer according to an embodiment.

FIG. 16 is a perspective view of the silencer of FIG. 15 cut along D-D′.

FIG. 17 is a perspective view illustrating a silencer according to an embodiment.

FIG. 18 is a perspective view illustrating a silencer according to an embodiment.

FIG. 19 is a perspective view of the silencer of FIG. 18 with a slit cover removed.

FIG. 20 is a perspective view of the silencer of FIG. 18 with the slit cover rotated.

FIG. 21 is a perspective view of the silencer of FIG. 18 cut along E-E′.

FIG. 22 is a perspective view of a silencer according to an embodiment.

FIG. 23 is a view illustrating a piston housing included in a configuration of the silencer of FIG. 22.

FIG. 24 is a side cross-sectional view of the silencer of FIG. 22 cut along F-F′.

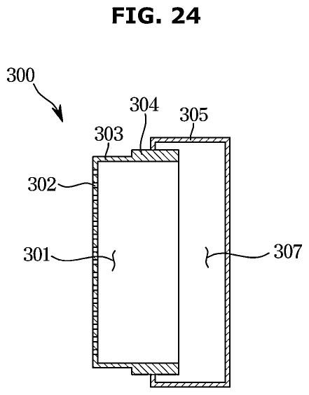

### MODES OF THE INVENTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In addition, as used in the following description, the terms “front”, “rear”, “top”, “bottom”, “left” and “right” are defined with reference to the drawings and are not intended to limit the shape and position of each element.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

In referring to the direction of rotation, the clockwise direction may be represented as a first direction and the counterclockwise direction, which is the opposite of the first direction, as a second direction. Such representations may be used in describing specific details for implementing the disclosure, but the direction of rotation of the elements of the disclosure is not limited by these terms.

Hereinafter, various embodiments according to the disclosure will be described in detail with reference to the accompanying drawings.

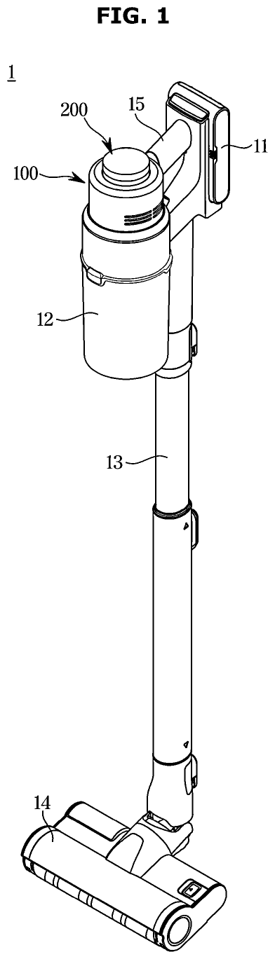

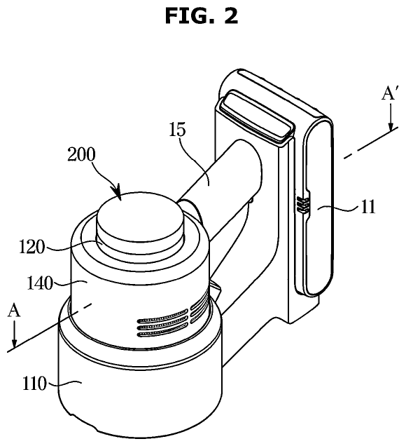

FIG. 1 is a perspective view of a vacuum cleaner including a silencer according to an embodiment. FIG. 2 is a perspective view showing a main body of FIG. 1.

Referring to FIGS. 1 and 2, a vacuum cleaner 1 may include an intake head 14 configured to draw in foreign matter, such as dust, from a surface to be cleaned by an intake force of air, and a main body 100 configured to capture foreign matter drawn in through the intake head 14.

The vacuum cleaner 1 may include an extension tube 13 configured to connect between the intake head 14 and the main body 100.

The intake head 14 may include an intake brush (not shown) and may be in close contact with the surface to be cleaned to draw in air and foreign matter from the surface to be cleaned. The intake head 14 may be rotatably coupled to the extension tube 13.

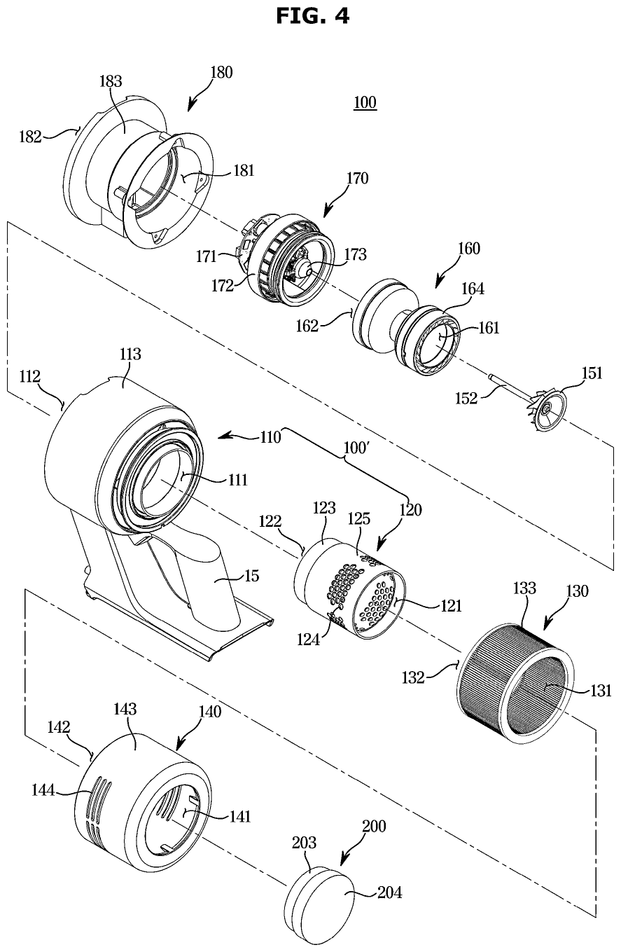

The extension tube 13 may be formed as a tube having a predetermined stiffness or a flexible hose. The extension tube 13 may transmit the intake force generated by an intake motor 173 (see FIG. 4) inside the main body to the intake head 14, and guide the drawn-in air and foreign matter, such as dust, through the intake head 14 to a foreign matter filtering portion 12 and the main body 100, which will be described later.

The main body 100 may include a handle 15. The handle 15 may be configured to be gripped by a user.

The main body 100 may include a battery 11 configured to provide power required to drive the configurations of the vacuum cleaner 1.

The foreign matter filtering portion 12 configured to filter foreign matter from the air may be mounted on a lower portion of the main body 100.

A silencer 200 may be mounted on an upper portion of the main body 100. The silencer 200 will be described in more detail later.

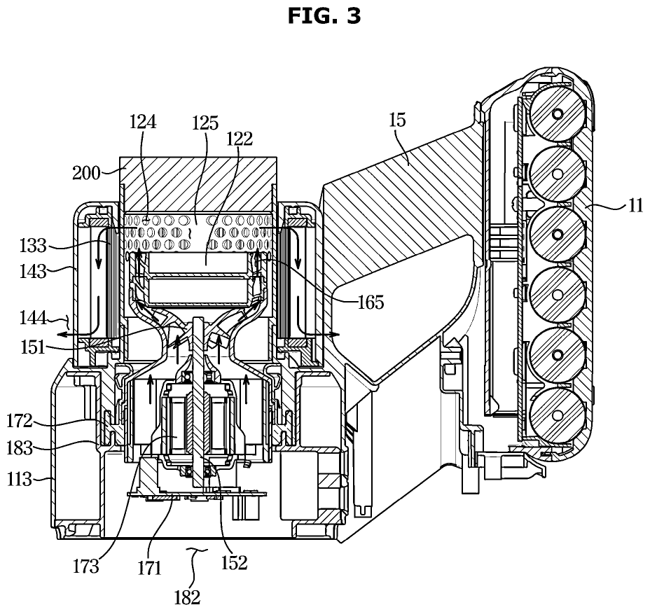

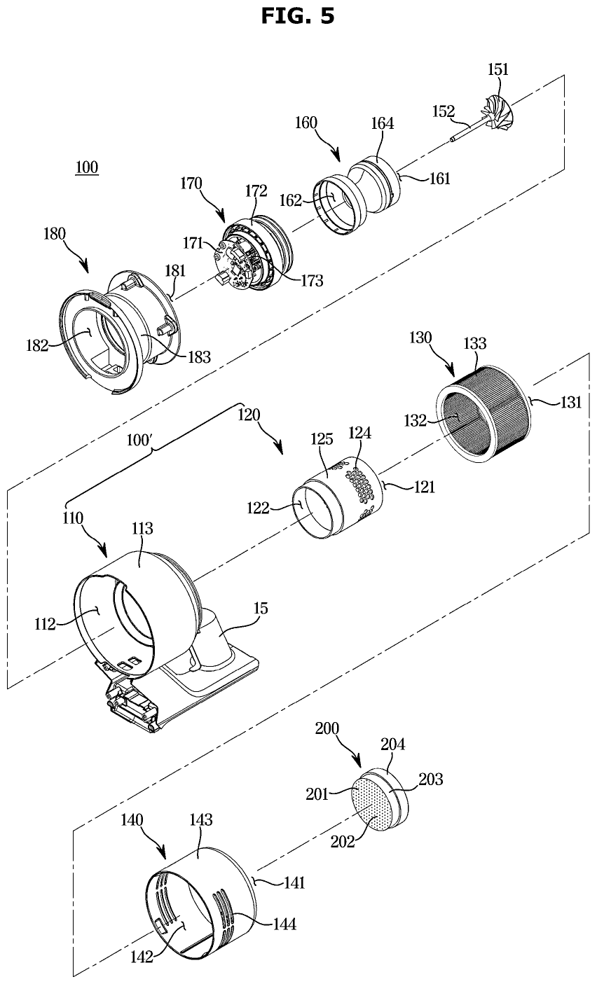

FIG. 3 is a cross-sectional view of the vacuum cleaner of FIG. 2 cut along A-A′. FIG. 4 is a partially exploded view of the vacuum cleaner including a silencer, according to an embodiment, viewed diagonally from above. FIG. 5 is a view of FIG. 4 viewed diagonally from below.

In the following, a structure of various configurations forming the main body 100 and their position relative to each other will be discussed.

A main body housing 100′ may be defined as a configuration in which a base housing 110 and an exhaust flow tube 120 are coupled. Accordingly, an interior of the base housing 110 may refer to an interior of the main body housing 100′. Similarly, an interior of the exhaust flow tube 120 may also refer to the interior of the main body housing 100′. All of these may be used interchangeably hereinafter.

Referring to FIGS. 3 to 5, the vacuum cleaner 1 may include the main body housing 100′.

The base housing 110 may include a base housing body 113 having a substantially cylindrical shape.

The base housing 110 may include a first base housing opening 111 arranged on one side of the base housing body 113. The base housing 110 may include a second base housing opening 112 arranged on the other side of the base housing body 113.

The first base housing opening 111 and the second base housing opening 112 may be configured to communicate with each other and penetrate the base housing body 113 in a longitudinal direction.

The handle 15 may be arranged on one side of the base housing body 113. The battery 11 may be arranged on one side of the handle 15 to be mountable.

The first base housing opening 111 may have a smaller diameter than the second base housing opening 112, but is not limited thereto.

The vacuum cleaner 1 may include a motor assembly 170. The motor assembly 170 may include the intake motor 173. The motor assembly 170 may include a circuit board 171. The circuit board 171 may be powered and operable by the battery 11. The circuit board 171 may be electrically connected to the intake motor 173. As a result, the circuit board 171 may cause the intake motor 173 to operate.

The operation of the intake motor 173 may generate noise that is uncomfortable to a user.

The motor assembly 170 may include a motor cover 172. The motor cover 172 may include a hollow cylindrical shape. The circuit board 171 and the intake motor 173 may be accommodated within the motor cover 172.

The vacuum cleaner 1 may include a motor assembly cover 180. The motor cover 172 of the motor assembly 170 may be accommodated within the motor assembly cover

The motor assembly cover 180 may include a motor assembly cover body 183. The motor assembly cover body 183 may include an approximately cylindrical shape. The motor assembly cover 180 may include a first motor assembly cover opening 181 arranged on one side thereof. The motor assembly cover 180 may include a second motor assembly cover opening 182 arranged on the other side. The first motor assembly cover opening 181 and the second motor assembly cover opening 182 may be configured to communicate with each other and penetrate the motor assembly cover body 183 in a longitudinal direction.

The motor assembly cover 180 may be inserted through the second base housing opening 112 of the base housing 110 and received within the base housing 110. In other words, the motor cover 172 may be positioned inside the motor assembly cover 180, and the intake motor 173 and the circuit board 171 may be positioned inside the motor cover 172.

The vacuum cleaner 1 may include an intake fan 151 driven by the intake motor 172. The intake fan 151 may be provided with a rotation shaft 152. The rotation shaft 152 may be connected to the intake motor 173. In other words, the rotation shaft 152 may rotate in response to the operation of the intake motor 173 by the circuit board 171. This may cause the intake fan 151 to rotate to form an intake airflow.

Upon rotation of the intake fan 151, noise that is uncomfortable to the user may be generated.

The vacuum cleaner 1 may include an intake fan cover 160. A portion of the intake fan cover 160 may be inserted into the motor cover 172. In particular, a portion of the intake fan cover 160 on a first intake fan cover opening 161 side may be inserted into the motor cover 172. The intake fan cover 160 may be completely received within the base housing 110. As a result, the intake motor 173 and the intake fan 151 may be received in the main body housing 100′ comprising the base housing 110 and the exhaust flow tube 120. The intake fan cover 160 and the motor cover 172 may communicate with each other.

The intake fan cover 160 may have an approximately hollow, conically curved shape, the diameter of which gradually narrows and then widens again. In other words, the intake fan cover 160 may have a shape approximately similar to an hourglass.

The intake fan cover 160 may include the first intake fan cover opening 161 arranged on one side facing the intake motor 173. The intake fan cover 160 may include a second intake fan cover opening 162 arranged on the other side. The first intake fan cover opening 161 and the second intake fan cover opening 162 may communicate with each other and penetrate the intake fan cover 160. This may cause the intake fan cover 160 and the motor cover 172 to communicate with each other. In addition, the intake fan cover 160 and the motor assembly cover 180 may communicate with each other.

The vacuum cleaner may include a diffuser 164. The diffuser 164 may include an approximately cylindrical shape. The diffuser 164 may include a diffuser flow path 165 configured to penetrate the diffuser 164 in the longitudinal direction.

The diffuser 164 may be inserted into the second intake fan cover opening 162 of the intake fan cover 160. This may allow the diffuser 164 and the intake fan cover 160 to be coupled. In addition, the diffuser 164 and the intake fan cover 160 may communicate with each other.

The vacuum cleaner 1 may include the exhaust flow tube 120. The exhaust flow tube 120 may be arranged on the first base housing opening 111 side of the base housing 110.

The exhaust flow tube 120 may include an exhaust flow tube body 125 having an approximately cylindrical shape. The exhaust flow tube body 125 may include exhaust holes 124.

One end of the exhaust flow tube body 125 positioned in a direction opposite to the base housing 110 may be provided as a connecting portion 123. The connecting portion 123 may be smaller diameter than the exhaust flow tube body 125, but is not limited thereto.

The exhaust flow tube 120 may include a first exhaust flow tube opening 121 arranged on the other side. The exhaust flow tube 120 may include a second exhaust flow tube opening 122 arranged on one side. The first exhaust flow tube opening 121 and the second exhaust flow tube opening 122 may communicate with each other and penetrate the exhaust flow tube body 125 in the longitudinal direction.

The connecting portion 123 may be inserted into the first base housing opening 111 of the base housing 110. As a result, the exhaust flow tube 120 may be coupled to the base housing 110. The exhaust flow tube 120 may be detachably arranged to the base housing 110. The exhaust flow tube 120 may be arranged to communicate with the base housing 110.

The vacuum cleaner 1 may include a filter 130. The filter 130 may include a filter body 133 having an approximately cylindrical shape.

The filter 130 may include a first filter opening 131 arranged on one side of the filter body 133. The filter 130 may include a second filter opening 132 arranged on the other side of the filter body 133. The first filter opening 131 and the second filter opening 132 may communicate with each other and penetrate the filter body 133 in the longitudinal direction.

The filter 130 may be positioned to surround the exhaust flow tube 120. In other words, the diameter of the first filter opening 131 or the second filter opening 132 may be larger than the diameter of the first exhaust flow tube opening 121.

The filter may be positioned to cover the exhaust holes 124. As a result, the air filtered from the foreign matter filtering portion 12 may pass through the exhaust holes 124 and be filtered again in the filter 130 to be discharged to an outside in a clean state.

A length of the filter body 133 in the longitudinal direction may be shorter than the length of the exhaust flow tube 120 in the longitudinal direction. In other words, based on the filter 130 mounted on the vacuum cleaner 1, the other end of the exhaust flow tube 120 may protrude into the first filter opening 131 of the filter 130.

The vacuum cleaner 1 may include a discharge housing 140. The discharge housing 140 may include a discharge housing body 143 having an approximately cylindrical shape. The discharge housing 140 may include a second discharge housing opening 142 arranged on one side facing the base housing 110. The discharge housing 140 may include a first discharge housing opening 141 arranged on the other side. The first discharge housing opening 141 and the second discharge housing opening 142 may communicate with each other and be configured to penetrate the discharge housing body 143.

The discharge housing 140 may include an outlet 144 arranged on one side of the discharge housing body 143.

The discharge housing 140 may accommodate the filter 130. In other words, the diameter of the second discharge housing opening 142 may be larger than the diameter of the first filter opening 131.

A length of the discharge housing body 143 in the longitudinal direction may be longer than the length of the filter body 133 in the longitudinal direction. In other words, based on the discharge housing 140 and the filter 130 being mounted to the vacuum cleaner 1, the discharge housing 140 may be configured to completely accommodate the filter 130.

The length of the discharge housing body 143 in the longitudinal direction may be shorter than the length of the exhaust flow tube 120 in the longitudinal direction. In other words, based on the discharge housing 140 and the exhaust flow tube 120 being mounted to the vacuum cleaner 1, the other end of the exhaust flow tube 120 may protrude into the first discharge housing opening 141 of the discharge housing 140.

The vacuum cleaner 1 may include the silencer 200 configured to reduce noise inside the base housing 110. The silencer 200 may be inserted into the first exhaust flow tube opening 121 of the exhaust flow tube 120 and may be detachably mounted to the exhaust flow tube 120. In other words, the silencer 200 may be detachably mounted to the main body housing 100′.

The silencer 200 may be arranged to be mounted at one end of the exhaust flow tube 120, and thus the increase in volume of the main body 100 of the vacuum cleaner 1 may be minimized. The detailed structure, operating method, and operating principle of the silencer 200 will be described later.

In the following, a process of drawing air into and discharging air from the inside of the vacuum cleaner 1 will be discussed in relation to the configurations described above.

Referring to FIGS. 3 to 5, upon operation of the vacuum cleaner 1, the intake motor 173 may be driven by an electrical signal from the circuit board 171. In response to driving of the intake motor 173, intake pressure may be generated.

The intake pressure may create an intake force to draw foreign matter from the surface to be cleaned into the intake head 14. The intake force may force air to be drawn into the intake head 14 together with foreign matter. The drawn-in air may move from the intake head 14 to the foreign matter filtering portion 12 through the extension tube 13. The foreign matter filtering portion 12 may remove foreign matter in the air. The air from which the foreign matter has been removed in the foreign matter filtering portion 12 may be discharged to an upper side of the foreign matter filtering portion 12. The air discharged to the upper side of the foreign matter filtering portion 12 may be introduced into the base housing 110. In particular, the air discharged to the upper side of the foreign matter filtering portion 12 may be introduced into the second motor assembly cover opening 182 of the motor assembly cover 180 received in the base housing 110. The air introduced into the second motor assembly cover opening 182 may be introduced into the second intake fan cover opening 162 and into the interior of the intake fan cover 160 that is in communication with the motor assembly cover 180. The air introduced into the interior of the intake fan cover 160 may pass through the intake fan 151 and be introduced into the diffuser 164 that is in communication with the intake fan cover 160. In particular, the air introduced into the interior of the intake fan cover 160 may be introduced into the diffuser flow path 165 of the diffuser 164. The air introduced into the diffuser flow path 165 of the diffuser 164 may pass through the diffuser flow path 165 and move into the interior of the exhaust flow tube 120. The air moved into the interior of the exhaust flow tube 120 may flow within the exhaust flow tube 120. The air flowing within the exhaust flow tube 120 may come into contact with the silencer 200. In other words, the silencer 200 may be configured to communicate with the interior of the exhaust flow tube 120 that guides the airflow from the intake fan 151 to the outside of the base housing 110.

This may eliminate the frequency of a specific noise band, thereby reducing the noise generated by the intake motor 173 and the intake fan 151.

The flow, which has been reduced in noise by contact with the silencer 200 may be exhausted to the outside of the exhaust flow tube 120 through the exhaust holes 124. In particular, the silencer 200 may be arranged to face the intake fan 151 so as to contact the flow, and a plurality of through holes 202 may be positioned on a downstream side of the exhaust holes 124 in a direction of the airflow inside the exhaust flow tube 120.

The flow exhausted to the outside of the exhaust flow tube 120 may pass through the filter 130. This may allow the air passing through the foreign matter filtering portion 12 to be in a state in which foreign matter is further removed.

The flow passed through the filter 130 may move to the interior of the discharge housing 140. Thereafter, the air may be finally discharged to the outside through the outlet 144 provided in the discharge housing body 143.

In the following, the configuration and structure of the silencer 200 and the principle of noise reduction by the silencer 200 will be discussed.

The silencer 200 may include a first silencer housing 203 having a hollow cylindrical shape. The silencer 200 may include a second silencer housing 204 having a hollow cylindrical shape. The first silencer housing 203 may be arranged to protrude from the second silencer housing 204, but is not limited thereto. The first silencer housing 203 and the second silencer housing 204 may communicate with each other.

The first silencer housing 203 may be provided with a contact surface 201 on one side thereof. The silencer 200 may be arranged such that the contact surface 201 is exposed to the interior of the exhaust flow tube 120. Although the contact surface 201 and the exhaust flow tube 120 are shown in the drawings as being arranged vertically, but are not limited thereto, and they may be arranged to abut at a certain angle or in line with each other.

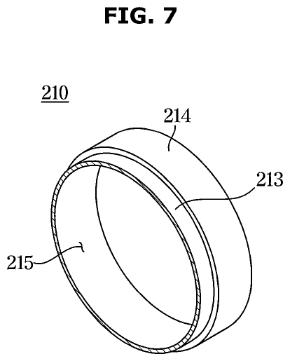

The contact surface 201 may be provided with the plurality of through holes 202. In particular, the plurality of through holes 202 may be positioned on the contact surface 201 to allow the interior of the exhaust flow tube 120 and a noise chamber 215 (see FIG. 7) inside the silencer 200 to communicate with each other.

In particular, the contact surface 201 may be provided as a microporous panel (MPP) including micropores or may be provided in the form of a Helmholtz resonator. A detailed description of specific types of the silencer 200 and accordingly the shape, arrangement, and the like of the plurality of through holes 202 will be described later.

Air in contact with the silencer 200 may not be directly introduced into the plurality of through holes 202. In other words, no air may pass through the plurality of through holes 202 arranged on the contact surface 201 of the silencer 200, but only noise having a frequency of a target band to be removed may pass through. This may refer to that the flow not passing through and only the sound waves passing through the plurality of through holes 202. Because the flow does not pass directly through the plurality of through holes 202, the velocity of the flow may not be reduced because there is no obstacle in the flow progression. Because the velocity of the flow is not reduced, the performance of the vacuum cleaner 1 may not be deteriorated.

The sound waves having the frequency of the target band to be removed that are introduced into the silencer 200 through the plurality of through holes 202 may have their energy reduced within the silencer 200. In particular, the sound energy of the sound waves may be converted into heat energy or other energy to reduce the sound energy that causes the noise, thereby reducing the noise. A sum of the length of the first noise housing 203 in the longitudinal direction and the length of the second noise housing 204 in the longitudinal direction may be shorter than the length of the wavelength of the sound waves having the frequency of the target band to be removed. In particular, the sum of the length of the first noise housing 203 in the longitudinal direction and the length of the second noise housing 204 in the longitudinal direction may be arranged to be one-tenth or less of the wavelength of the sound wave having the frequency of the target band to be removed.

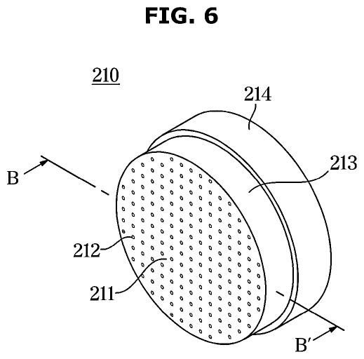

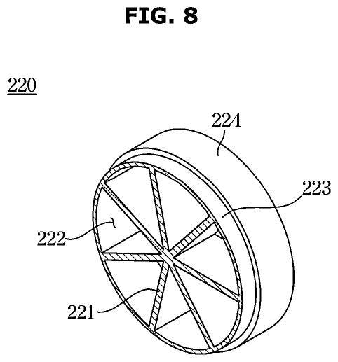

FIG. 6 is a perspective view of a silencer according to an embodiment. FIG. 7 is a perspective view of the silencer of FIG. 6 cut along B-B′. FIG. 8 is a perspective view of a chamber inner wall of the silencer according to an embodiment. The silencers 210, 220, and 230 have similar structures and any redundant descriptions have been omitted. The differences among the silencers 210, 220 and 230 are shown below.

Referring to FIGS. 6 to 8, a silencer 210 may be a silencer including a MPP. The silencer 210 may include a first noise housing 213. The silencer 210 may include a second noise housing 214. The first noise housing 213 may be arranged to protrude from the second noise housing 214. The diameter of the first noise housing 213 may be less than the diameter of the second noise housing 214, but is not limited thereto. The first noise housing 213 may include a contact surface 211. The silencer 210 may include the noise chamber 215 partitioned from the interior of the exhaust flow tube 120 by the contact surface 211. In other words, the interior of the exhaust flow tube 120 and the noise chamber 215 may be distinguished by the contact surface 211.

A silencer 220 may include a first noise housing 223. The silencer 220 may include a second noise housing 224. The first noise housing 223 may be arranged to protrude from the second noise housing 224. The diameter of the first noise housing 223 may be less than the diameter of the second noise housing 224, but is not limited thereto. The first noise housing 223 may include a contact surface 221. The silencer 220 may further include a chamber inner wall 221 that partitions the interior of the silencer 220 into a plurality of chambers 222 of the silencer 220. In other words, the volume of the interior of the silencer 220 may be adjusted by partitioning into the plurality of chambers 222.

The contact surface 211 may include micropores 212. The micropores 212 may be configured to have holes each having a diameter of 1 mm or less. The micropores 212 may be uniformly arranged on the contact surface 211.

The silencer 210 including the MPP may be designed to selectively remove only noise including frequencies of the target band to be removed. In particular, the diameter of the micropores 212, the thickness of the contact surface 211, the length of the noise chamber 215 in the longitudinal direction, the volume of the noise chamber 215, and the porosity (ratio of the area of the micropores 212 to the area of the contact surface 211) may be used as design factors to set the frequency of the target band to be removed. For example, the longer the length of the noise chamber 215 in the longitudinal direction and the smaller the porosity, the lower the frequency of the band may be removed.

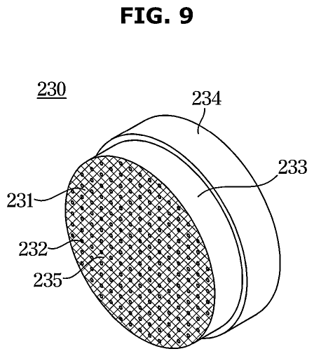

FIG. 9 is a perspective view of a silencer according to an embodiment.

Referring to FIG. 9, A silencer 230 may include a first noise housing 233. The silencer 230 may include a second noise housing 234. The first noise housing 233 may be arranged to protrude from the second noise housing 234. The diameter of the first noise housing 233 may be less than the diameter of the second noise housing 234, but is not limited thereto. The first noise housing 233 may include a contact surface 231. The silencer 230 may include a mesh cover 235 on the contact surface 231. In particular, the mesh cover 235 may be arranged to cover the micropores 232 provided on the contact surface 231. In reducing noise by the silencer 230, air does not directly pass through the micropores 232. However, the air may come into contact with the contact surface 231. In response to the air coming into contact with the contact surface 231, the air may interact with the micropores 232 provided on the contact surface 231 to create vortices. The resulting vortices may generate additional noise. In other words, noise having frequencies except for the frequency of the target band to be removed may cause the side effect of increasing.

In this case, when the mesh cover 235 is arranged to cover the micropores 232, the air may be blocked by the mesh cover 235 and prevented from directly contacting the micropores 232, but sound waves in the noise band may still enter the micropores 232. Accordingly, the interaction between the air and the micropores 232 may be prevented, thereby avoiding the side effect of additional noise.

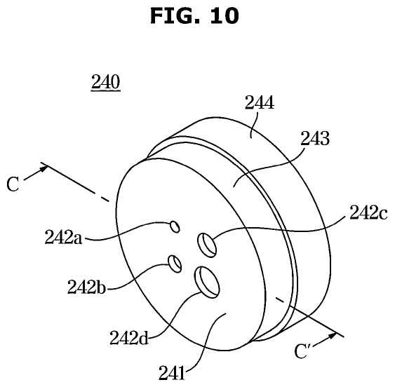

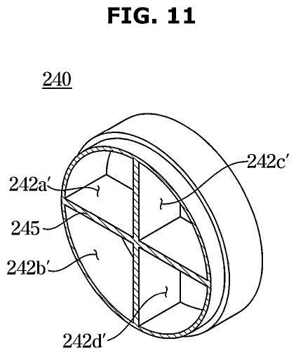

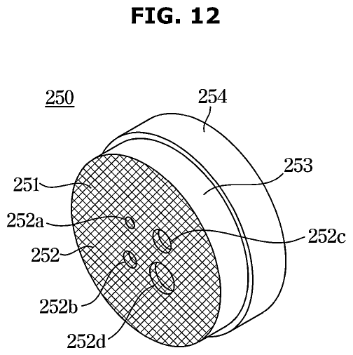

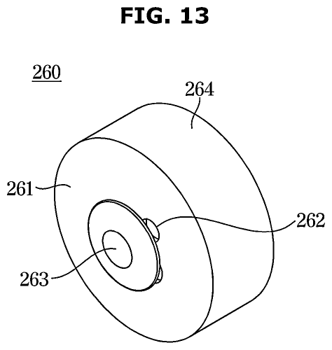

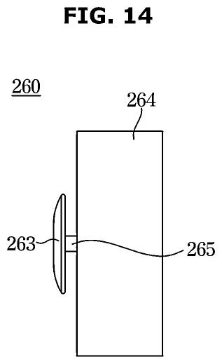

FIG. 10 is a perspective view showing a silencer according to an embodiment. FIG. 11 is a perspective view of the silencer of FIG. 10 cut along C-C′. FIG. 12 is a perspective view showing a silencer according to an embodiment. FIG. 13 is a perspective view showing a silencer according to an embodiment. FIG. 14 is a side view of FIG. 13.

In the following, redundant descriptions of those above will be omitted.

Referring to FIGS. 10 to 14, A silencer 240 may include a first noise housing 243. The silencer 240 may include a second noise housing 244. The first noise housing 243 may be arranged to protrude from the second noise housing 244. The diameter of the first noise housing 243 may be less than the diameter of the second noise housing 244, but is not limited thereto. The first noise housing 243 may include a contact surface 241. The silencer 240 may include a resonator-type silencer. In particular, the resonator-type silencer may be a Helmholtz resonator, but is not limited thereto. The contact surface 241 may include a plurality of through holes 242a, 242b, 242c and 242d, and the plurality of through holes 242a, 242b, 242c and 242d may be arranged to have different diameters. The interior of the silencer 240 may be divided into a plurality of chambers 242a′, 242b′, 242c′ and 242d′ by chamber inner walls 245. The plurality of through holes 242a, 242b, 242c and 242d provided in the contact surface 241 may be arranged to correspond to the plurality of chambers 242a′, 242b′, 242c′ and 242d′, respectively, and thus, they may communicate with the plurality of chambers 242a′, 242b′, 242c′ and 242d′, respectively.

The silencer 240 utilizing the Helmholtz resonator may be designed to selectively remove only noise including frequencies of the target band to be removed. In particular, the frequency of the target band to be removed may be set by using design factors, such as the cross-sectional areas of the plurality of through holes 242a, 242b, 242c and 242d, the thickness of the contact surface 241 on which the plurality of through holes 242a, 242b, 242c and 242d are formed, and the volume of the interior of the silencer 240. For example, the smaller the cross-sectional area of the plurality of through holes 242a, 242b, 242c and 242d, the larger the thickness of the contact surface 241 on which the plurality of through holes 242a, 242b, 242c and 242d are formed, and the larger the volume of the interior of the silencer 240, the lower the frequency of the band may be removed.

The Helmholtz-type silencer 240 may be provided with different sizes of the plurality of through holes 242a, 242b, 242c and 242d and different volumes of the plurality of chambers 242a′, 242b′, 242c′ and 242d′ communicating with the through holes 242a, 242b, 242c and 242d, respectively. Accordingly, by adjusting the above factors, noise of different frequency bands may be reduced simultaneously even when a single Helmholtz-type silencer 240 is mounted.

A silencer 250 may include a first noise housing 253. The silencer 250 may include a second noise housing 254. The first noise housing 253 may be arranged to protrude from the second noise housing 254. The diameter of the first noise housing 253 may be less than the diameter of the second noise housing 254, but is not limited thereto. The first noise housing 253 may include a contact surface 251. A plurality of through holes 252a, 252b, 252c and 252d provided in a Helmholtz-type silencer 250 may also not allow air to pass through. However, as in the silencer 210 including the MPP (see FIG. 6), the interaction of the contact surface 251 with the flow of air may have the side effect of creating vortices that may generate additional noise.

To prevent such a situation, the silencer 250 may include a mesh cover 252 configured to cover the plurality of through holes 252a, 252b, 252c and 252d. In response to the mesh cover 252 covering the plurality of through holes 252a, 252b, 252c and 252d, the interaction between the flow of air and the plurality of through holes 252a, 252b, 252c and 252d may be prevented, thereby avoiding the side effect of generating additional noise.

A silencer 260 may include a first noise housing 263. The silencer 260 may include a second noise housing 264. The first noise housing 263 may be arranged to protrude from the second noise housing 264. The diameter of the first noise housing 263 may be less than the diameter of the second noise housing 264, but is not limited thereto. The first noise housing 263 may include a contact surface 261. In addition to the method including the mesh cover 252, in order to prevent additional noise in a Helmholtz-type silencer, the silencer 260 may include a through hole guard 263 arranged to be spaced apart from a contact surface 261 so as to cover a plurality of through holes 262.

As the through hole guard 263 covers the plurality of through holes 262, the interaction of the flow of air with the plurality of through holes 262 may be prevented, and only sound waves in the noise band may enter the plurality of through holes 262. This may reduce noise while preventing side effects.

The through hole guard 263 may be mounted to a silencer 260 in combination with a through hole guard support 265 provided perpendicularly to the contact surface 261.

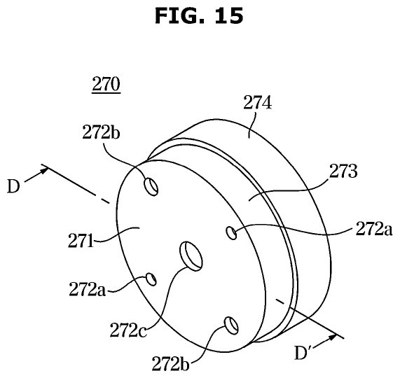

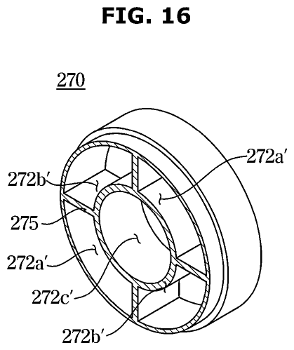

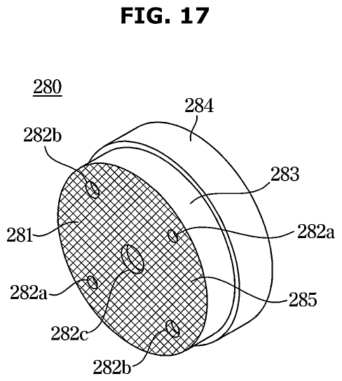

FIG. 15 is a perspective view showing a silencer according to an embodiment. FIG. 16 is a perspective view of the silencer of FIG. 15 cut along D-D′. FIG. 17 is a perspective view showing a silencer according to an embodiment.

In the following, redundant descriptions of those above will be omitted.

Referring to FIGS. 15 to 17, A silencer 270 may include a first noise housing 273. The silencer 270 may include a second noise housing 274. The first noise housing 273 may be arranged to protrude from the second noise housing 274. The diameter of the first noise housing 273 may be less than the diameter of the second noise housing 274, but is not limited thereto. The first noise housing 273 may include a contact surface 271. A plurality of through holes 272a, 272b and 272c may include a first through hole 272a having a first diameter, include a second through hole 272b having a second diameter different from the first diameter, and a third through hole 273c having a third diameter different from the first diameter and the second diameter.

In other words, the plurality of through holes 272a, 272b and 272c may include through holes having the same diameter as each other, and may include through holes having different diameters.

A silencer 270 may further include a chamber inner wall 275 that partitions the interior of the silencer 270 into a plurality of chambers 272a′, 272b′ and 272c′. The plurality of through holes 272a, 272b and 272c may be arranged to correspond to the plurality of chambers 272a′, 272b′ and 272c′ and to communicate with each other.

Referring to FIG. 17, a silencer 280 may include a first noise housing 283. The silencer 280 may include a second noise housing 284. The first noise housing 283 may be arranged to protrude from the second noise housing 284. The diameter of the first noise housing 283 may be less than the diameter of the second noise housing 284, but is not limited thereto. The first noise housing 283 may include a contact surface 281. A plurality of through holes 282a, 282b and 282c are similar to the plurality of through holes 272a, 272b and 272c, so the description is omitted.

The silencer 280 may include a mesh cover 285 configured to cover the plurality of through holes 282a, 282b, and 282c. In response to the mesh cover 285 covering the plurality of through holes 282a, 282b, and 282c, the interaction between the flow of air and the plurality of through holes 282a, 282b, and 282c may be prevented, thereby avoiding the side effect of generating additional noise.

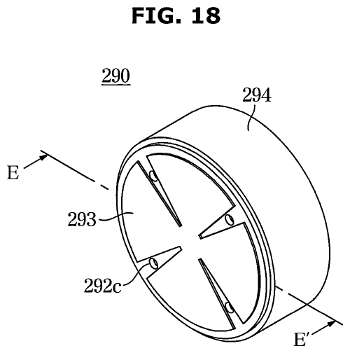

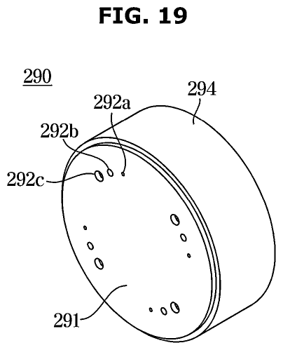

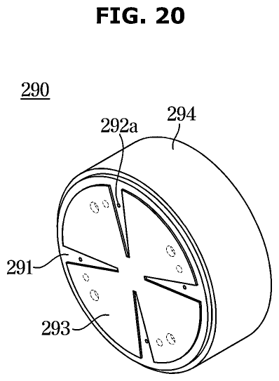

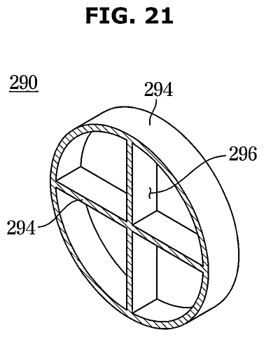

FIG. 18 is a perspective view showing a silencer according to an embodiment. FIG. 19 is a perspective view of the silencer of FIG. 18 with a slit cover removed. FIG. 20 is a perspective view of the silencer of FIG. 18 with the slit cover rotated. FIG. 21 is a perspective view of the silencer of FIG. 18 cut along E-E′.

In the following, redundant descriptions of those above will be omitted.

Referring to FIGS. 18 to 21, a silencer 290 may include a noise housing 294. The noise housing 294 may include a contact surface 291. The silencer 290 may further include a chamber inner wall 295 that partitions the interior of the silencer 290 into a plurality of chambers 296 of the silencer 290.

The silencer 290 includes a first through hole 292a and a second through hole 292c may be arranged alternately along a circumferential direction of the contact surface. Although a plurality of through holes 292a, 292b and 292c are shown in the drawings as having three different diameters, but the number of the types may be reduced or increased.

A silencer 290 may be configured to cover the plurality of through holes 292a, 292b and 292c and may include a slit cover 293 configured to be rotatable to open or close the first through holes 292a to the second through holes 292b to the third through holes 292c. In response to rotation of the slit cover 293, the types of the plurality of through holes 292a, 292b and 292c in contact with the flow of air may change. Accordingly, although the frequency of the target band to be removed changes depending on the output of the intake motor 173 of the vacuum cleaner 1, the frequency of the target band to be removed may be effectively removed by exposing and changing the plurality of through holes 292a, 292b and 292c capable of removing the corresponding frequency to the inside of the exhaust flow tube 120. The manner in which the slit cover 293 is rotated may be provided in variety of ways.

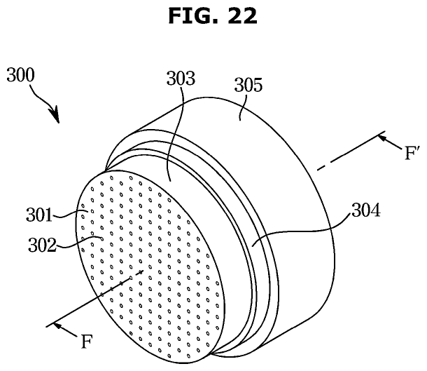

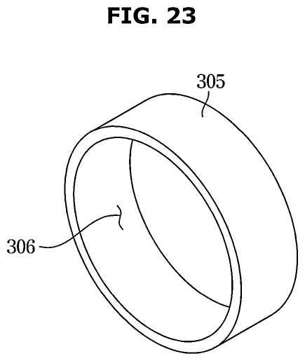

FIG. 22 is a perspective view illustrating a silencer according to an embodiment. FIG. 23 is a side cross-sectional view of the silencer of FIG. 22 cut along F-F′. In the following, redundant descriptions of those above will be omitted.

Referring to FIGS. 22 and 23, a silencer 300 may include a first noise housing 303 and a second noise housing 304. The first noise housing 303 may be arranged to protrude from the second noise housing 304. The diameter of the first noise housing 303 may be less than the diameter of the second noise housing 304, but is not limited thereto. The first noise housing 303 may include a contact surface 301. The contact surface 301 may include micropores 302.

the vacuum cleaner 1 may further include a cylindrical piston housing 305 including a circular coupler 306. The silencer 300 may be inserted into the coupler 306 so as to be in communication with the piston housing 305. The opposite side of the contact surface 301 of the silencer 300 may be configured to be open toward the piston housing 305. Accordingly, the interior of the silencer 300 may be configured to be in communication with the noise chamber 307 of the piston housing 305. The silencer 300 may be movably arranged within the piston housing 305 to vary the volume of a noise chamber 307. In response to the silencer 300 moving within the piston housing 305, the volume of the noise chamber 307 may change. This may allow the frequency of the target band to be removed may be varied.

The power source that allows the silencer 300 to move within the piston housing 305 may be intake pressure by the intake fan 151, but is not limited thereto.

In FIGS. 22 and 23, the silencer in the form of the MPP is shown with the piston housing 305, but this is by way of example only and may be adapted to other silencers as well as a Helmholtz-type silencer.

While the present disclosure has been particularly described with reference to exemplary embodiments, it should be understood by those of skilled in the art that various changes in form and details may be made without departing from the spirit and scope of the present disclosure.

What is claimed is:

1. A vacuum cleaner comprising;
an intake motor;
an intake fan to be driven by the intake motor to generate an airflow;
a main body housing configured to accommodate the intake motor and the intake fan; and
a silencer having one end coupled to the main body housing and configured to reduce noise inside the main body housing during an operation of the intake motor; and
wherein the silencer comprises:
a contact surface disposed in the one end of the silencer to face the intake fan so as to be in contact with the airflow;
a noise chamber partitioned from an inside of the main body housing by the contact surface; and
a plurality of through holes arranged in the contact surface to have the noise chamber to be in communication with an inside of the main body housing through the plurality of through holes.

2. The vacuum cleaner of claim 1, wherein
the main body housing comprises an opening on one side, and
the one end of the silencer is inserted into the opening and detachably mounted on the main body housing.

3. The vacuum cleaner of claim 1, wherein
the main body housing further comprises an exhaust hole through which air is discharged to an outside of the main body housing, and
the plurality of through holes is positioned on a downstream side of the exhaust hole in a direction of the airflow inside the main body housing.

4. The vacuum cleaner of claim 1, wherein
the plurality of through holes is micropores and uniformly arranged on the contact surface.

5. The vacuum cleaner of claim 4, wherein
the silencer further comprises a chamber inner wall that partitions the noise chamber into a plurality of chambers.

6. The vacuum cleaner of claims claim 4, wherein
the silencer further comprises a mesh cover configured to cover the micropores.

7. The vacuum cleaner of claim 1, wherein
the silencer further comprises a chamber inner wall that partitions the noise chamber into a plurality of chambers, and
each of the plurality of through holes is arranged to correspond to each of the plurality of chambers and to be in communication with each of the plurality of chambers, respectively.

8. The vacuum cleaner of claim 7, wherein
the silencer further comprises a mesh cover configured to cover the plurality of through holes.

9. The vacuum cleaner of claim 7, wherein
the silencer further comprises a through hole guard arranged to be spaced apart from the contact surface to cover the plurality of through holes.

10. The vacuum cleaner of claim 1, wherein
the plurality of through holes comprises first through holes having a first diameter and second through holes having a second diameter different from the first diameter,
the silencer further comprises a chamber inner wall partitioning the noise chamber into a plurality of chambers, and
the plurality of through holes is arranged to correspond to each of the plurality of chambers to be in communication with each of the plurality of chambers, respectively.

11. The vacuum cleaner of claim 10, wherein
the first through holes and the second through holes are arranged alternately along a circumferential direction of the contact surface, and
the silencer further comprises a slit cover configured to cover the plurality of through holes, and rotatable to selectively open or close the first through holes and the second through holes.

12. The vacuum cleaner of claim 4, further comprising a cylindrical piston housing including a circular coupler,
wherein an other end of the silencer is inserted into the coupler so as to be in communication with the piston housing, and the silencer is movable within the piston housing so as to change a volume of the noise chamber.

13. The vacuum cleaner of claim 7, further comprising a cylindrical piston housing including a circular coupler,
wherein an other end of the silencer is inserted into the coupler so as to be in communication with the piston housing, and the silencer is movable within the piston housing so as to change a volume of the noise chamber.

14. The vacuum cleaner of claim 10, further comprising a cylindrical piston housing including a circular coupler,
wherein an other end of the silencer is inserted into the coupler so as to be in communication with the piston housing, and the silencer is movable within the piston housing so as to change a volume of the noise chamber.

15. The vacuum cleaner of claim 12, wherein the other end of the silencer has an opening to communicate with an inside of the cylindrical piston housing so that the volume of the noise chamber is adjusted based on a movement of the silencer within the piston housing.

16. The vacuum cleaner of claim 13, wherein the other end of the silencer has an opening to communicate with an inside of the cylindrical piston housing so that the volume of the noise chamber is adjusted based on a movement of the silencer within the piston housing.

17. The vacuum cleaner of claim 14, wherein the other end of the silencer has an opening to communicate with an inside of the cylindrical piston housing so that the volume of the noise chamber is adjusted based on a movement of the silencer within the piston housing.

18. The vacuum cleaner of claim 5, wherein the silencer further comprises a mesh cover configured to cover the micropores.

19. The vacuum cleaner of claim 1, wherein the plurality of through holes is configured to pass noise having a frequency of a target band to be removed therethrough.

20. The vacuum cleaner of claim 10, wherein the first through holes and the second through holes are configured to pass through noise corresponding to the diameter of the first through holes and the diameter of second through holes, respectively.
